(19) United States
(12) Patent Application Publication
(10) Pub. No.: US 2009/0196604 A1
(43) Pub. Date: Aug. 6, 2009

(54) System for combining high-definition video control signals for transmission over an optical fiber

(76) Inventors: Eric B. Grann, San Ramon, CA (US); Steve Rapinchuk, San Jose, CA (US)

Correspondence Address: Bruce H. Johnsonbaugh;Eckhoff & Hoppe, Suite 2800, 101 Montgomery Street, San Francisco, CA, 94104, US

(21) Appl. No.: 12/322,556

(22) Filed: Feb. 4, 2009

Related U.S. Application Data
(60) Provisional application No. 61/063,718, filed on Feb. 6, 2008.

(51) Int. Cl. H04B 10/24

(52) U.S. Cl. 398/41

(57) ABSTRACT

An apparatus and method are provided for combining, transmitting and receiving two or more high definition video control signals, namely, DDC and HDCP over a single bi-directional optical fiber or a duplex optical fiber, wherein a source and a sink are in communication with each other through the apparatus, and wherein the sink includes EDID and HDCP registers. A single transmitter module and receiver module pair are provided wherein the transmitter module includes replications of the sink EDID and HDCP registers, whereby any write request from the source to the sink is stored within the replicated EDID and HDCP registers so that any read request from the source to the sink can be answered immediately. Optional high definition video control signals may also be included in the system including Hot Plug, CEC, 5V and infrared.

### CROSS-REFERENCE TO RELATED APPLICATION

This application claims the benefit of and priority from U.S. provisional application Ser. No. 61/063,718 filed Feb. 6, 2008.

### BACKGROUND AND BRIEF SUMMARY

High definition video signals have increased in data rate to a point where transmission over traditional copper cables is limited in distance. Transmitting the video signal over one or more optical fibers is one solution that can overcome the distance limitation. However, the numbers of electrical signals that are used to connect a video source to a sink are high and a direct mapping of each electrical signal to an optical channel would not be cost effective.

The present invention combines the video control signals into a single transmit and receive pair for transmission over a single bidirectional optical fiber or a duplex optical fiber. In order to overcome the response time of a read request from the source I²C (Inter-Integrated Circuit) interface, the EDID (extended display identification data) and HDCP (high-bandwidth digital content protection) registers are replicated at the transmitter side. While utilizing the clock stretching feature within the I²C standard could be used to delay a read request from the source, many DVD manufacturers have not implemented this required specification. Therefore, the invention disclosed was developed to overcome these non-standard I²C implementations.

The prior art includes Tong et al US2007/0003288, which teaches a single fiber for bi-directional communication for HDCP transmission systems. A significant disadvantage of Tong et al is that it is limited to HDCP systems. Those systems use proprietary technology owned by Intel Corporation for which a license and license fees are required. The present invention is not limited to HDCP systems, and may be used with a variety of video control systems, namely, DDC (digital down converter), HDCP, Hot Plug, 5V and CEC (consumer electronics control), as well as others.

A primary object of the invention is to provide an optical fiber system for transmitting and receiving HD video over longer distances than possible with electrical cables.

A further object is to provide an optical communication system using only one or two optical fibers capable of transmitting a wide variety of video control signals.

Another object is to provide an optical communication system for HD video control signals wherein an instant or immediate response is provided to a read request from the source unit or receiver.

A further object is to provide an HD video control transmission system that does not require an HDCP license or the use of special key codes.

Other objects and advantages will become apparent from the following description and drawings.

### BRIEF DESCRIPTION OF THE DRAWINGS

FIG. 1 shows a block diagram of the source and transmitter module; and

FIG. 2 shows a block diagram of the sink and receiver module.

### DETAILED DESCRIPTION OF THE INVENTION

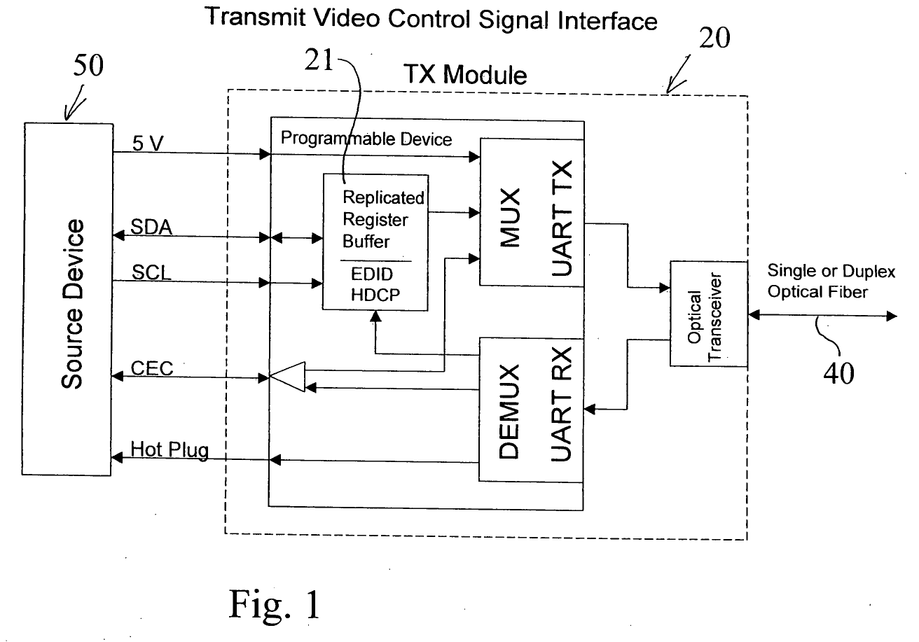

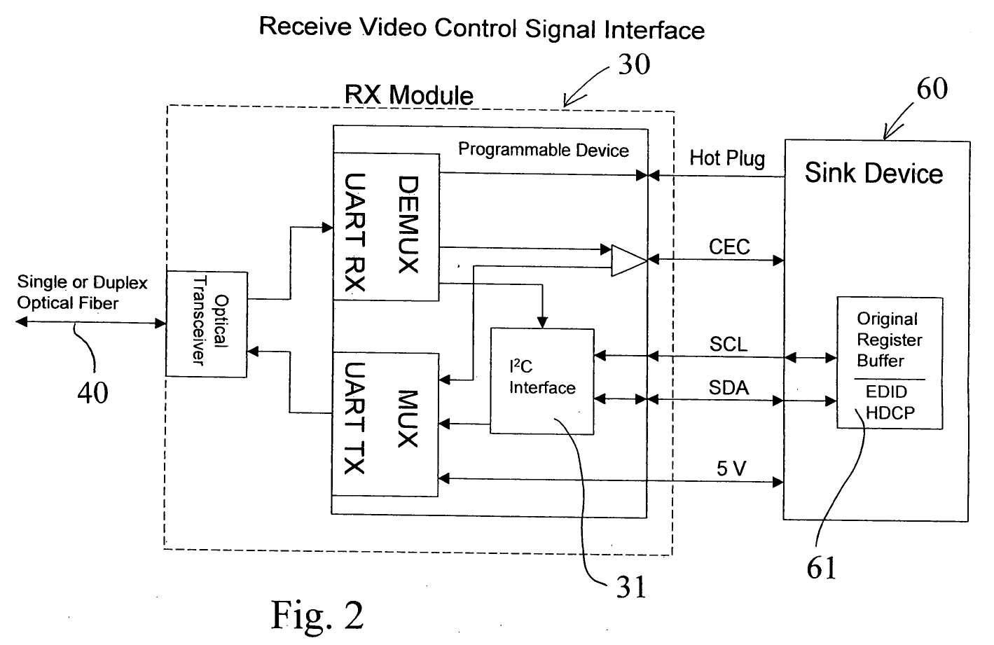

The invention described within this disclosure combines two or more video control signals into a single transmit (TX) module 20 and receiver (RX) module 30 pair for transmission over one or two optical fibers shown as 40. FIGS. 1 and 2 illustrate a single transmitter module 20 and receiver module 30 pair in optical communication with each other through either a single bidirectional optical fiber or a duplex optical fiber 40. A source 50, such as a DVD player, is in communication with transmit module 20. A sink 60, such as a TV or computer monitor, is in communication with receiver module 30. The source 50 and sink 60 are in communication with each other through transmit module 20 and receiver module 30. In order to overcome any delay in time from an I²C read request from the receiver I²C interface 31, the EDID and HDCP registers 61 of sink 60 are replicated at the transmit module 20 as shown at 21. Upon initialization, the Transmit Video Control Signal Interface (or transmitter) 20 reads the EDID and HDCP registers 61 at the sink 60. The register values at registers 61 are then replicated at the EDID and HDCP registers 21 of Transmit Video Control Signal Interface (or transmitter) 20 such that a read request from the source 50 via I²C interface to sink 60 can be answered immediately. Any source I²C write request is stored within the replicated register set 21 and is also transmitted across the optical interface to the sink register set 61. Several HDCP sink registers are updated on a continuous basis (every 128 video frames, approximately 2 seconds) in order to protect the video content being transmitted over the link. The source 50 will request these HDCP registers either asynchronously (approximately 2 seconds) or synchronously (every 128 frames). In the worst case, the source 50 may request the updated HDCP registers on the frame following the update at the sink 60. Therefore, in order for the Transmit Video Control Signal Interface (or transmit module) 20 to have a correct register set, it is necessary to poll the sink HDCP registers 61 at a rate faster than the frame rate, and continuously update the replicated registers 21.

Alternatively, when the transmit module 20 receives from the source 50, it sends a short read request to the sink 60. The sink 60 responds immediately with the first byte which is loaded into the transmitter module local register set 21 before the source 50 can read it. Additionally, the Transmit and Receive Video Control Signal Interfaces 20 and 30 must continuously communicate the 5V, Hot Plug, and CEC status indicator signals back and forth. Information transferred over the UART (universal asynchronous receiver/transmitter) is either a command or data. The UART is nine bits wide; the ninth bit designates if the preceding eight bits are a command or data. Since there are not that many commands, not all eight bits are needed.

In the preferred embodiment, the eight bits being transmitted from the transmit module 20 to the receiver module 30 are used to transmit the following:
Bits 0,1,2=Commands
Bit 3=5V status indicator
Bit 4=CEC status indicator
Bits 5,6=Commands
Bit 7=Register flag, wherein
   1=Register command
   0=Normal command
      The eight bits transmitted from receiver module 30 to transmit module are used to transmit the following:
Bits 0,1=Command
Bit 2=Video loss of signal
Bit 3=Hot Plug status indicator
Bit 4=CEC status indicator
Bit 5=User defined indicator, for example, infrared
Bit 6=Command
Bit 7=Register flag

The UART interface is transmitted and received over an optical interface. A duplex fiber implementation requires a single transmit laser and receiver photodiode for each fiber. A bidirectional fiber implementation requires the transmit and receive optical signals to propagate on the same optical fiber. Typically, this is performed by having the forward and backward optical channels operate at different wavelengths. At each respective optical interface, means for separating the different wavelengths is present.

In an alternate embodiment of the invention, only two high definition video control signals are combined, transmitted and received; namely, DDC and HDCP. The optional video control signals; namely, Hot Plug, CEC, 5V, may be included as desired. Additionally, a user defined indicator such as infrared may also be included as desired.

There are several hardware solutions for implementing this type of invention. The lowest cost implementation is through the use of a microcontroller or other programmable integrated circuit.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. An apparatus for combining, transmitting and receiving at least two high definition video control signals, namely, DDC and HDCP over a single bidirectional optical fiber or a duplex optical fiber, wherein a source and a sink are in communication with each other through said apparatus, and wherein said sink includes EDID and HDCP registers, said apparatus comprising:
a single transmitter module and a single receiver module pair in optical communication with each other through either a single bidirectional optical fiber or a duplex optical fiber, and
said transmitter module includes replications of said sink EDID and HDCP registers, whereby any write request from said source to said sink is stored within said replicated EDID and HDCP registers in said transmitter module, and wherein any read request from said source to said sink can be answered immediately.

2. The apparatus of claim 1 further comprising means for transmitting and receiving the status of Hot Plug.

3. The apparatus of claim 1 further comprising means for transmitting and receiving the status of CEC.

4. The apparatus of claim 1 further comprising means for transmitting and receiving the status of 5V.

5. The apparatus of claim 1 further comprising means for transmitting and receiving the status of an infrared indicator.

6. A method for combining, transmitting and receiving two or more high definition video control signals, namely, DDC, HDCP, over a single bidirectional optical fiber or a duplex optical fiber, wherein a single transmitter module and receiver module pair are in optical communication with each other through either a single bidirectional optical fiber or a duplex optical fiber, wherein a source and a sink are in communication with each other through said single transmitter module and receiver pair, and wherein said sink includes EDID and HDCP registers, comprising the steps:
replicating said EDID and HDCP registers of said sink in said transmitter module,
storing any write request from said source to said sink within said replicated EDID and HDCP registers in said transmitter module, and
answering any read request from said source to said sink immediately.

7. The method of claim 6 wherein Hot Plug is also used as a video control signal.

8. The method of claim 6 wherein CEC is also used as a video control signal.

9. The method of claim 6 wherein 5V is also used as a video control signal.

10. The method of claim 6 wherein infrared is also used as a video control signal.
